(19) United States
(12) Patent Application Publication
(10) Pub. No.: US 2022/0185986 A1
(43) Pub. Date: Jun. 16, 2022

(54) ANTIDEGRADANT BLEND

(71) Applicant: SI GROUP SWITZERLAND (CHAA) GMBH, Pratteln (CH)

(72) Inventors: Warren J. EBENEZER, Stockport (GB); Jonathan HILL, Manchester (GB)

(21) Appl. No.: 17/612,810

(22) PCT Filed: May 28, 2020
(86) PCT No.: PCT/EP2020/064931

§ 371 Date: Nov. 19, 2021

(30) Foreign Application Priority Data
May 30, 2019 (GB) 1907622.3

(51) Int. Cl. C08K 3/014; C08K 3/32; C08K 3/30; C08K 5/52; C08K 5/32; C08K 13/02

(52) U.S. Cl. CPC C08K 3/014; C08K 3/32; C08K 3/30; C08K 2201/012; C08K 5/32; C08K 13/02; C08K 5/52

(57) ABSTRACT

The invention concerns an antidegradant blend, comprising: an aminic component comprising a hydroxylamine and/or a hydroxylamine precursor; and an inorganic antioxidant or reducing agent.

The present invention relates to antidegradant blends. More specifically, but not exclusively, the present invention relates to antidegradant blends for stabilising polymers, for example polyolefins.

Polymers are used in a wide variety of applications. For many polymer applications, it is desirable for the polymer to retain certain properties during storage, handling and subsequent application. More specifically, it may be desirable for the polymer to retain its melt flow properties (as measured by melt flow rate or MFR), viscosity and have good colour stability, even during prolonged or repeated exposure to heat.

To aid retention of polymer properties such as melt flow, viscosity and colour stability, it is known to add different types of additives to the polymer, for example phenolic antioxidants, organic phosphite antioxidants, acid scavengers, or combinations thereof.

The control of colour is a considerable problem in polymer processing, and especially in polyolefins. Customers desire polymer items, such as food containers, to be white because alternative colouring may insinuate a lack of quality and cleanliness, or an undesirable age of the product. Colour has always been one of the most difficult polymer properties to control at a reasonable cost.

EP0538509 describes an antioxidant resin composition containing a resin, a solution of a hypophosphite compound in an organic solvent, a heat stabilizer and a hindered amine base weathering stabilizer, which has improved heat stability and weather resistance.

CN102503821 describes the use of sodium hypophosphite as an antioxidant in a polymerization process.

U.S. Pat. No. 3,691,131 describes heat stabilized synthetic polyamide compositions prepared by incorporating therein a mixture of a phenolic antioxidant and metal hypophosphite, a copper compound and metal halide. A typical embodiment includes polyamides which are stabilized with 1,2-bis[3,5-di-t-butyl-4-hydroxyphenyl)-propionamido]ethane and sodium hypophosphite, copper acetate and potassium iodide.

WO2014152237 describes a polycarbonate composition comprising metallic salts of phosphoric acid, at least one of which is a potassium salt of phosphoric acid.

WO2018202791 describes a stabilising composition comprising: at least one antioxidant comprising one or more of: a phenolic antioxidant; a phosphite antioxidant; a sulphur-containing antioxidant; and an aminic antioxidant; at least one buffering agent; and a secondary inorganic antioxidant, wherein the buffering agent has the capacity to buffer in aqueous solution at a pH range from 4 to 8. The buffering agent typically comprises one or more metal phosphates and/or metal pyrophosphates. The secondary inorganic antioxidant is said to comprise one or more of a metal hypophosphite, a metal thiosulphate, a metal bisulphite, a metal metabisulphite and/or a metal hydrosulphite. It was found that a stabilising composition with a hydrated metal hypophosphite, for example a monohydrate metal hypophosphite, performs comparably to, and in some instances better than, a stabilising composition with the anhydrous form of the metal hypophosphite at the same phosphorous loading.

GB2567456 describes an antidegradant blend, comprising: a metal carboxylate; an inorganic phosphite; and a phenolic antioxidant. This document describes that the presence of a metal carboxylate and an inorganic phosphite in the antidegradant blend produces a synergistic effect with respect to the colour stability of a variety of polymers. More specifically, it was found that the combination of a metal carboxylate and an inorganic phosphite in the antidegradant blend causes a significant reduction in colour formation. The synergistic effect was said to be particularly apparent where the metal carboxylate is a metal stearate and the inorganic phosphite is a metal hypophosphite.

WO2019211235 describes an antidegradant blend, comprising an antioxidant selected from one or more of a phenolic antioxidant; an organic phosphite antioxidant; and an inorganic antioxidant or reducing agent, wherein the blend is absent any metal carboxylate or buffering agent having the capacity to buffer in aqueous solution at a pH range from 4 to 8.

CN105949671 describes a UV-resistant flame retardant fibre optic cable material which is composed of 2-(2′-hydroxy-5′-tert-octylphenyl)benzotriazole, polyvinyl chloride, polystyrene, sodium hypophosphite monohydrate, polyformaldehyde, 35-37% hydrochloric acid, chlorospirophosphate, aluminium chloride hexahydrate, triethylamine, graphite powder, polyvinyl butyral resin, magnesium oxide, dimethyl chlorophthalate, calcium palmitate, lauryldimethylamine oxide, ethylene glycol monobutyl ether and aluminium dihydrogen phosphate.

WO9424344 describes blends of long chain N,N-dialkylhydroxylamines, selected phosphites and selected hindered amines for providing processing, long term heat aging and light stability performance to polypropylene fibres in the absence of a conventional phenolic antioxidant.

US2006142446 describes a stabilized flame retardant polyolefin composition containing a hydrated metal compound, for example a metal hydroxide, as a flame retardant; and an effective stabilizing amount of a synergistic stabilizer, for example an amine oxide, a hydroxyl amine, nitrone, nitroxyl stabilizer, and an organophosphorus compound or mixtures thereof.

There remains a need for an improved additive blend which provides better performance than has hitherto been realised in connection with polymer properties such as discolouration.

According to an aspect of the present invention, there is provided an antidegradant blend, comprising:
a. an aminic component comprising a hydroxylamine and/or a hydroxylamine precursor; and
b. an inorganic antioxidant or reducing agent.

Also provided in accordance with the invention is an antidegradant blend according to the above which, when added to a polymeric base material, causes the yellowness index (YI) of the polymeric base material (measured by ASTM D1925) to rise less over five passes through an extruder at 260° C. in air, than that of the same polymeric base material to which an equivalent w/w amount of an equivalent antidegradant blend, absent one or both of component a. and component b., has been added.

For example, the antidegradant blend of the invention, when added to a polymeric base material, may cause the yellowness index of the polymeric base material (measured by ASTM D1925) to rise by at least 20% less, over five passes through an extruder at 260° C. in air, than that of the same polymeric base material to which an equivalent w/w amount of an equivalent antidegradant blend, absent one or both of component a. and component b., has been added.

The antidegradant blend which, when added to a polymeric base material, may cause the yellowness index of the polymeric base material (measured by ASTM D1925) to rise by less than 2.3, less than 2, less than 1.8, less than 1.5, or less than 1, over five passes through an extruder at 260° C. in air.

The antidegradant blend may comprise one or more of: a phenolic antioxidant, an organic phosphite antioxidant, a sulphur-containing antioxidant, and an anti-acid.

The antidegradant blend may comprise either or both of a phenolic antioxidant and an organic phosphite antioxidant.

It is well known that the use of phenolic or organic phosphite antioxidant additives and especially additive blends comprising organic phosphite antioxidants in combination with phenolic antioxidants, gives improved heat aging performance in polymers such as polypropylene. However, it has now been surprisingly found that the addition of an aminic component comprising a hydroxylamine and/or a hydroxylamine precursor, and an inorganic antioxidant or reducing agent to such a blend produces an improvement in the colour protection in multi-pass thermal aging experiments.

It has been found that the use of such combinations of antidegradant blends is particularly beneficial in polymers and leads to improvements in the processing and long-term heat aging performance of the polymers.

Without wishing to be bound by theory, it is believed that the hydroxylamine of the antidegradant blend is successively oxidised to a nitrone. Subsequently, the inorganic antioxidant or reducing agent is able to reduce the nitrone back to the original hydroxylamine. This process effectively regenerates the relatively expensive aminic component, and thus permits the use of a low ppm amount of said aminic component, for example less than about 45 ppm, less than about 35 ppm, or less than about 30 ppm in the polymeric composition.

The inventors of the present invention have surprisingly found that the combination of stabilising components in the antidegradant blend significantly improves the colour retention of a wide range of polymers (as measured by yellowness index), especially polyolefins, even during prolonged or repeated exposure to heat and/or shear. Many polymer processing operations are high shear due to the high viscosity of the polymer, for example extrusion is a high shear environment.

Without wishing to be bound by theory, it is believed that the addition of the inventive antidegradant blend to a polymer leads to significantly less derived colour in the polymer (as measured by the multi-pass thermal aging experiments) compared to stabilising blends of the art.

This antidegradant blend represents an unexpected and previously unachievable level of colour control for a compounded polymeric material and may completely remove the problem of colour formation from polymer processing.

In addition, it has been found that the polymer to which the antidegradant blend is added retains its melt flow properties, even during prolonged or repeated exposure to heat and/or shear.

The improved colour stability and retention of melt flow properties during prolonged or repeated exposure to heat and/or shear is advantageous since polymers are often kept in a molten state for prolonged periods of time during production and prior to use in an application, and shear forces may be present at any point during polymer processing operations.

By ‘prolonged heat exposure’ it is meant exposure to a temperature of at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C. or at least about 250° C., for at least about 1 hour, at least about 2 hours, at least about 4 hours, at least about 6 hours, at least about 12 hours, at least about 24 hours, at least about 36 hours, at least about 48 hours, at least about 3 days, at least about 4 days, at least about 5 days, at least about 6 days, at least about 7 days, at least about 10 days or at least about 14 days.

By ‘repeated heat exposure’ it is meant exposure to a temperature of at least about 100° C., at least about 150° C., at least about 200° C., at least about 250° C., or at least about 300° C., on more than one occasion, for at least about 5 seconds, at least about 10 seconds, at least about 20 seconds, at least about 30 seconds, at least about 1 minute, at least about 5 minutes, or at least about 10 minutes. Repeated heat exposure may be experienced during multiple passes through an extruder. For example, a polymeric composition may be subjected to repeated cycles of exposure to high temperature and high shear forces followed by cooling to ambient conditions. The combination of high shear and heat is a potent force for causing polymer degradation, and the antidegradant blend of the invention is intended to mitigate those effects.

The antidegradant blend may be absent any buffering agent having the capacity to buffer in aqueous solution at a pH range from 4 to 8. In particular, the blend may be absent any metal phosphates and/or metal pyrophosphates as disclosed in WO2018202791.

By ‘absent’ it is meant that the amount of the material in the antidegradant blend is less than about 1% w/w, less than about 0.5% w/w, less than about 0.2% w/w, or completely absent, i.e. 0% w/w.

It is believed that the inorganic antioxidant or reducing agent has a dual function in that it behaves as an anti-acid and as an inorganic antioxidant or reducing agent.

The inorganic antioxidant or reducing agent may comprise a phosphorus-containing compound and/or a sulphur-containing compound.

The inorganic antioxidant or reducing agent may comprise one or more of a metal phosphite, a metal hypophosphite, a metal thiosulphate, a metal bisulphite, a metal metabisulphite and/or a metal hydrosulphite. Mixtures of any two or more thereof may also be used.

The metal of the phosphite, hypophosphite, thiosulphate, bisulphite, metabisulphite and/or hydrosulphite may be an alkali metal and/or an alkaline earth metal. The alkali metal may be selected from lithium (Li), sodium (Na), and potassium (K). The alkaline earth metal may be selected from calcium (Ca) and magnesium (Mg).

The metal phosphite may be selected from compounds with the formula M₂HPO₃. The metal hypophosphite may be selected from compounds with the formula: MPO₂H₂. The metal thiosulphate may be selected from compounds with the formula: M₂S₂O₃. The metal bisulphite may be selected from compounds with the formula: MHSO₃. The metal metabisulphite may be selected from compounds with the formula: M₂S₂O₅. The metal hydrosulphite may be selected from compounds with the formula: M₂S₂O₄. In each case, M is an alkali metal cation. The alkali metal cation may be selected from lithium (Li), sodium (Na), and potassium (K).

Preferably, the inorganic antioxidant or reducing agent comprises a phosphorus-containing compound, optionally a metal phosphite and/or a metal hypophosphite.

The metal phosphite may be anhydrous. Alternatively, the metal phosphite may be hydrated, for example a monohydrate or a poly-hydrated metal phosphite. The metal phosphite may comprise disodium phosphite, optionally disodium phosphite pentahydrate.

The inorganic antioxidant or reducing agent may comprise a metal hypophosphite, optionally sodium hypophosphite.

In the antidegradant blends of the invention the combinatory effect of a metal hypophosphite (for example sodium hypophosphite) and a hydroxylamine (or a precursor thereof) has been found to be especially effective in improving colour stability.

The metal hypophosphite may be anhydrous. The metal hypophosphite may be hydrated, for example a monohydrate or poly-hydrated metal hypophosphite.

The metal hypophosphite may be provided in mono-hydrated form.

The inorganic antioxidant or reducing agent may be present in an amount of from about 0.1% to about 40%, from about 1% to about 30%, from about 5% to about 25%, from about 10% to about 20%, or from about 14% to about 18%, by weight of the antidegradant blend.

The inorganic antioxidant or reducing agent may be a solid at ambient conditions.

In this context, by ‘ambient conditions’ it is meant a temperature of about 50° C. or lower, a temperature of about 40° C. or lower, a temperature of about 30° C. or lower, or a temperature of about 25° C. or lower, and about 1 atmosphere pressure i.e. 101.325 kPa.

The inorganic antioxidant or reducing agent may be a solid at a temperature of about 25° C. and about 1 atmosphere pressure i.e. 101.325 kPa.

The inventors of the present invention have surprisingly found that a solid inorganic antioxidant or reducing agent can be used in the antidegradant blend. Inorganic antioxidants or reducing agents of the prior art have often been used as solutions. In some instances, the solution has been achieved by dissolving the inorganic antioxidant or reducing agent in an organic solvent such as ethylene glycol. Providing the inorganic antioxidant or reducing agent as a solid provides handling benefits during processing as the solid inorganic antioxidant or reducing agent can be more easily compounded into the polymer. In addition, the expense and time involved in dissolving the inorganic antioxidant or reducing agent in an organic solvent is removed, and the environmental impact of using an, often toxic, organic solvent is eliminated.

The aminic component comprises a hydroxylamine and/or a hydroxylamine precursor. The aminic component may comprise a single compound or a blend of two or more compounds.

The hydroxylamine may be of general formula RₓR_{y}NOH wherein each R independently denotes an optionally branched hydrocarbyl group having from 1 to 25 carbon atoms.

The hydroxylamine may comprise, for example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N-hexadecyl-N-octadecylhydroxylamine; N-heptadecyl-N-octadecylhydroxylamine; bis(octadecyl)hydroxylamine; and/or compatible mixtures of two or more thereof.

The hydroxylamine precursor may be an amine oxide which, when heated, gives a hydroxylamine. The amine oxide may comprise general formula RₓR_{y}R_{z}NO wherein each R independently denotes an optionally branched hydrocarbyl group having from 1 to 25 carbon atoms.

The aminic component may therefore comprise one or more hydroxylamines and/or one or more amine oxides.

In the following paragraphs, compounds designated by the tradenames ALKANOX™, ANOX™, GENOX™, LOWINOX™, NAUGARD™, ULTRANOX™ and WESTON™ are available from SI Group USA (USAA), LLC, 4 Mountainview Terrace, Suite 200, Danbury, Conn. 06810.

The aminic component may comprise bis(octadecyl)hydroxylamine (IRGASTAB™ FS042—CAS 143925-92-2, available from BASF) and/or amines, bis(hydrogenated rape-oil alkyl)methyl, N-oxides (GENOX™ EP—CAS 204933-93-7).

The aminic component may be a solid at ambient conditions (as previously defined). The aminic component may be a solid at a temperature of about 25° C. and about 1 atmosphere pressure i.e. 101.325 kPa.

The aminic component may be present in an amount of from about 0.1% to about 30%, from about 0.1% to about 20%, from about 0.5% to about 15%, from about 1% to about 10%, or from about 2% to about 4%, by weight of the antidegradant blend.

The ratio of inorganic antioxidant or reducing agent to aminic component may be from about 1:15 to about 15:1, from about 1:3 to about 14:1, from about 1:1 to about 13:1, from about 2:1 to about 12:1, or from about 5:1 to about 12:1.

The antidegradant blend may comprise a phenolic antioxidant. The phenolic antioxidant may comprise a single phenolic antioxidant or a blend of two or more phenolic antioxidants.

The phenolic antioxidant may comprise a partially hindered phenolic antioxidant and/or a hindered phenolic antioxidant. In this context, by ‘partially hindered’ it is preferably meant that the phenolic antioxidant comprises at least one substituent hydrocarbyl group ortho to the phenolic —OH group, where either none or only one of the or each substituent group is branched at the C₁ and/or C₂ position, preferably at the C₁ position, with respect to the aromatic ring. In this context, by ‘hindered’ it is preferably meant that the phenolic antioxidant comprises substituent hydrocarbyl groups on both positions ortho to the phenolic —OH group, each of those substituent groups being branched at the C₁ and/or C₂ position, preferably at the C₁ position, with respect to the aromatic ring.

The phenolic antioxidant may comprise, for example, 2-(1,1-dimethylethyl)-4,6-dimethyl-phenol (LOWINOX™ 624—CAS 1879-09-0); 6-tert-butyl-2-methylphenol (CAS 2219-82-1); 4,6-di-tert-butyl-2-methylphenol; 2-tert-butyl-4-methylphenol; 2-tert-butyl-5-methylphenol; 2,4-di-tert-butylphenol; 2,4-di-tert-pentylphenol; triethyleneglycol-bis-[3-(3-t-butyl-4-hydroxy-5-methylphenyl)propionate] (LOWINOX™ GP45—CAS 36443-68-2); 1,3,5-tris(4-t-butyl-3-hydroxyl-2,6-dimethylbenzyI)-1,3,5-triazine-2,4,6-(1H,3H,5H)-trione (LOWINOX™ 1790); 2,2′-ethylidenebis[4,6-di-t-butylphenol] (ANOX™ 29—CAS 35958-30-6); 2,2′methylenebis(6-t-butyl-4-methylphenol) (LOWINOX™ 22M46—CAS 119-47-1); the butylated reaction product of p-cresol and dicyclopentadiene (LOWINOX™ CPL—CAS 68610-51-5); 2,6-xylenol; C13-C15 linear and branched alkyl esters of 3-(3′5′-di-t-butyl-4′-hydroxyphenyl) propionic acid (ANOX™ 1315—CAS 171090-93-0); octadecyl 3-(3′,5′-di-t-butyl-4′-hydroxyphenyl) propionate (ANOX™ PP18—CAS 2082-79-3); N,N′-hexamethylene bis[3-(3,5-di-t-butyl-4-hydroxyphenyl)propionamide] (LOWINOX™ HD98—CAS 23128-74-7); C9-C11 linear and branched alkyl esters of 3-(3′,5′-di-t-butyl-4′-hydroxyphenyl)propionic acid (NAUGARD™ PS48—CAS 125643-61-0); butylated hydroxytoluene (BHT—CAS 128-37-0, available from Sigma-Aldrich); 2,6-di-tertiary-butyl-4-sec-butylphenol (ISONOX™ 132, available from SI Group Inc. of 2750 Balltown Road, Schenectady, N.Y. 12301, US); 2,6-di-tertiary-butyl-4-nonylphenol (ISONOX™ 232, available from SI Group Inc. of 2750 Balltown Road, Schenectady, N.Y. 12301, US); tetrakismethylene(3,5-di-t-butyl-4-hydroxyhydrocinnamate) methane (ANOX™ 20—CAS 6683-19-8); 1,3,5-tris(3,5-di-t-butyl-4-hydroxybenzyl) isocyanurate (ANOX™ IC14—CAS 27676-62-6); 1,2-bis(3,5-di-t-butyl-4-hydroxyhydrocinnamoyl)hydrazine (LOWINOX™ MD24—CAS 32687-78-8); 2,2′thiodiethylene bis[3(3,5-di-t-butyl-4-hydroxyphenyl)propionate] (ANOX™ 70—CAS 41484-35-9); 1,3,5-trimethyl-2,4,6-tris(3,5-di-t-butyl-4-hydroxybenzyl)benzene (ANOX™ 330—CAS 1709-70-2); butylated hydroxyanisole (BHA—CAS 25013-16-5, available from Sigma-Aldrich); DL α-tocopherol (CAS 10191-41-0, available from 15 Sigma-Aldrich or from BASF as IRGANOX™ E201); and/or compatible mixtures of two or more thereof.

The phenolic antioxidant may comprise tetrakismethylene (3,5-di-t-butyl-4-hydroxyhydrocinnamate) methane (ANOX™ 20—CAS 6683-19-8).

The phenolic antioxidant may comprise a food additive, for example butylated hydroxytoluene (BHT—CAS 128-37-0, available from Sigma-Aldrich); butylated hydroxyanisole (BHA—CAS 25013-16-5, available from Sigma-Aldrich); tocopherol, tocopherol derivatives, tocotrienol and tocotrienol derivatives (Vitamin E e.g. DL α-tocopherol—CAS 10191-41-0, available from Sigma-Aldrich or from BASF as IRGANOX™ E201); and/or compatible mixtures of two or more thereof.

The phenolic antioxidant may be a solid at ambient conditions (as previously defined). The phenolic antioxidant may be a solid at a temperature of about 25° C. and about 1 atmosphere pressure i.e. 101.325 kPa.

The phenolic antioxidant may be present in an amount of from about 1% to about 60%, from about 5% to about 55%, from about 10% to about 50%, from about 20% to about 45%, or from about 25% to about 35%, by weight of the antidegradant blend.

The antidegradant blend may comprise an organic phosphite antioxidant. The organic phosphite antioxidant may comprise a single organic phosphite antioxidant or a blend of two or more organic phosphite antioxidants.

The organic phosphite antioxidant may comprise, for example, bis(2,4,di-t-butylphenyl)pentaerythritol diphosphite (ULTRANOX™ 626—CAS 26741-53-7); 2,4,6-tri-tert-butylphenyl-2-butyl-2-ethyl-1,3-propanediol phosphite (ULTRANOX™ 641—CAS 161717-32-4); tris(2,4-di-t-butylphenyl)phosphite (ALKANOX™ 240—CAS 31570-04-4); tetrakis (2,4-di-t-butylphenyl)4,4′-biphenylene diphosphonite (ALKANOX™ 24-44—CAS 38613-77-3); tris(4-n-nonylphenyl)phosphite (WESTON™ TNPP—CAS 26523-78-4); distearylpentaerythritol diphosphite (WESTON™ 618—CAS 3806-34-6); bis(2,4-dicumylphenyl) pentaerythritol diphosphite (DOVERPHOS™ 9228—CAS 154862-43-8, available from Dover Chemical Corporation); WESTON™ 705—CAS 939402-02-5; tris(dipropyleneglycol) phosphite, C18H3909P (WESTON™ 430—CAS 36788-39-3); poly(dipropylene glycol) phenyl phosphite (WESTON™ DHOP—CAS 80584-86-7); diphenyl isodecyl phosphite, C₂₂H₃₁O₃P (WESTON™ DPDP—CAS 26544-23-0); phenyl diisodecyl phosphite (WESTON™ PDDP—CAS 25550-98-5); heptakis (dipropyleneglycol) triphosphite (WESTON™ PTP—CAS 13474-96-9); bis(2,6-di-tert-butyl-4-methylphenyl)pentaerythritol diphosphite (PEP 36—CAS 80693-00-1, available from Adeka Polymer Additives); tris(2-t-butylphenyl)phosphite (CAS 31502-36-0); and/or compatible mixtures of two or more thereof.

The organic phosphite antioxidant may comprise tris(2,4-di-t-butylphenyl)phosphite (ALKANOX™ 240—CAS 31570-04-4).

The organic phosphite antioxidant may be a solid at ambient conditions (as previously defined). The organic phosphite antioxidant may be a solid at a temperature of about 25° C. and about 1 atmosphere pressure i.e. 101.325 kPa.

The organic phosphite antioxidant may be present in an amount of from about 10% to about 90%, from about 20% to about 80%, from about 30% to about 70%, from about 40% to about 65%, or from about 50% to about 60%, by weight of the antidegradant blend.

The antidegradant blend may comprise a sulphur-containing antioxidant. The sulphur-containing antioxidant may comprise a single sulphur-containing antioxidant or a blend of two or more sulphur-containing antioxidants.

The sulphur-containing antioxidant may comprise one or more thioether groups. The sulphur-containing antioxidant may comprise one or more thioester groups. The sulphur-containing antioxidant may be a sulphur-containing phenolic antioxidant.

The sulphur-containing antioxidant may be a solid at ambient conditions (as previously defined). The sulphur-containing antioxidant may be a solid at a temperature of about 25° C. and about 1 atmosphere pressure i.e. 101.325 kPa.

The sulphur-containing antioxidant may comprise, for example, 4,6-bis(octylthiomethyl)-o-cresol (LOWINOX™ 520—CAS 110553-27-0); 2,2′thiodiethylene bis[3(3,5-di-t-butyl-4-hydroxyphenyl)propionate] (ANOX™70—CAS 41484-35-9); dilauryl thiodipropionate (NAUGARD™ DLTDP—CAS 123-28-4); distearyl thiodipropionate (NAUGARD™ DSTSP—CAS 693-36-7); ditridecylthiodipropionate (NAUGARD™ DTDTDP—CAS 10595-72-9); pentaerythritol tetrakis (p-laurylthiopropionate) (NAUGARD™ 412S—CAS 29598-76-3); 2,4-bis(dodecylthiomethyl)-6-methylphenol (IRGANOX™ 1726—CAS 110675-26-8, available from BASF); and/or compatible mixtures of two or more thereof.

The sulphur-containing antioxidant may comprise pentaerythritol tetrakis (β-laurylthiopropionate) (NAUGARD™ 412S—CAS 29598-76-3).

The sulphur-containing antioxidant may be present in an amount of from about 10% to about 90%, from about 20% to about 80%, from about 30% to about 70%, from about 40% to about 60%, or from about 45% to about 55%, by weight of the antidegradant blend.

The antidegradant blend may comprise an anti-acid. The anti-acid may comprise stearates, for example of lithium, sodium, calcium, zinc, magnesium or aluminium; oxides, such as zinc oxide or magnesium oxide or titanium dioxide; artificial or natural carbonates, such as calcium carbonate or hydrotalcite. The anti-acid may comprise calcium stearate.

The anti-acid may be present in an amount of from about 1% to about 60%, from about 2% to about 50%, from about 3% to about 40%, from about 6% to about 30%, or from about 8% to about 25%, by weight of the antidegradant blend.

The antidegradant blend may be a solid at ambient conditions (as previously defined). The antidegradant blend may be a solid at a temperature of about 25° C. and about 1 atmosphere pressure i.e. 101.325 kPa.

The antidegradant blend may be provided as a powder blend, in granular form, or in the form of non-dust blend granules, for example.

According to an aspect of the present invention, there is provided an antidegradant blend comprising:
a. an aminic component comprising a hydroxylamine and/or a hydroxylamine precursor;
b. an inorganic phosphite antioxidant;
c. a phenolic antioxidant; and
d. an organic phosphite antioxidant.

According to an aspect of the present invention, there is provided an antidegradant blend comprising:
a. bis(octadecyl)hydroxylamine (CAS 143925-92-2) and/or amines, bis(hydrogenated rape-oil alkyl)methyl, N-oxides (CAS 204933-93-7), present in an amount of from about 0.1° A to about 30% by weight of the antidegradant blend;
b. sodium hypophosphite, present in an amount of from about 0.1% to about 40% by weight of the antidegradant blend;
c. tetrakismethylene(3,5-di-t-butyl-4-hydroxyhydrocinnamate) methane (CAS 6683-19-8), present in an amount of from about 1% to about 60% by weight of the antidegradant blend; and
d. tris(2,4-di-t-butylphenyl)phosphite (CAS 31570-04-4), present in an amount of from about 10% to about 90% by weight of the antidegradant blend.

The antidegradant blend may comprise one or more further additives, selected from lactone radical scavengers, acrylate radical scavengers, clarifiers, antiblocks, UV absorbers or stabilisers, processing aids and/or chelating agents. Other additives may include lactates and/or benzoates, for example of calcium or sodium.

According to an aspect of the present invention, there is provided a method of maintaining colour formation in a polymeric base material using an antidegradant blend of the present invention.

According to an aspect of the present invention, there is provided a method of reducing colour formation in a polymeric base material using an antidegradant blend of the present invention.

The aforementioned methods may be applicable over the course of article manufacture conditions, prior to article manufacture, during storage, and/or during containment in an extruder at elevated temperatures while awaiting formation into a material.

According to an aspect of the present invention, there is provided use of the antidegradant blend of the invention to stabilise a polymer. The polymer may be a polyolefin.

According to an aspect of the present invention, there is provided a polymeric composition, comprising a polymeric base material and the antidegradant blend of the invention.

The antidegradant blend may be present in the polymeric composition in an amount of from about 0.01% to about 5% by weight of the polymeric composition. For example, the antidegradant blend may be present in an amount of from about 0.01% to about 2%, from about 0.01% to about 1%, or from about 0.1% to about 0.5% by weight of the polymeric composition.

The polymeric base material in the polymeric composition may comprise a polyolefin, polystyrene, polyacrylonitrile, a polyacrylate, a polyurethane, a polyamide, a polyester, a polycarbonate, polyvinyl chloride, polyoxyarylenes, polyoxyalkylenes, an elastomer, a rubber and/or suitable mixtures, blends or copolymers thereof.

The polymeric base material may comprise a polyolefin.

The polyolefin may comprise a homopolymer or a copolymer.

The polyolefin may comprise polyethylene, polypropylene, polybutylene or a higher polyalkene.

The polyolefin may comprise polyethylene and/or polypropylene.

The polyethylene may comprise low density polyethylene (LDPE), linear low density polyethylene (LLDPE), medium density polyethylene (MDPE) and/or high density polyethylene (HDPE).

The polyolefin may comprise a copolymer of ethylene, propylene and/or butylene. The copolymer may be a random copolymer or a block copolymer. For example, the polyolefin may comprise an ethylene/propylene block copolymer, an ethylene/propylene random copolymer, an ethylene/propylene/butylene random terpolymer or an ethylene/propylene/butylene block terpolymer.

The polyolefin may be produced using a catalyst selected from Ziegler-Natta, chromium or metallocene catalysts.

Additionally or alternatively, the polymeric base material may comprise a rubber. For example, the polymeric base material may comprise a styrenic block copolymer. The styrenic block copolymer may be selected from styrene-butadiene-styrene (SBS); styrene-isoprene-styrene (SIS); styrene-ethylene/butylene-styrene (SEBS); styrene-ethylene/propylene (SEP); styrene-butadiene rubber (SBR); or suitable mixtures or blends thereof.

Additionally or alternatively, the polymeric base material may comprise an ethylene vinyl acetate polymer, for example EVA.

According to an aspect of the present invention, there is provided a useful article manufactured from the polymeric composition of the invention. The article may comprise extruded nonwoven material (such as a meltspun spunbond or meltblown fabric), an extruded or blown film, or a moulded article of manufacture.

The antidegradant blend, which when added to a polymeric base material, may cause the yellowness index of the polymeric base material (measured by ASTM D1925) to rise less over five passes through an extruder at 260° C. in air, than that of the same polymeric base material to which an equivalent w/w amount of an equivalent antidegradant blend, absent one or both of component a. and component b., has been added.

The antidegradant blend, which when added to a polymeric base material, may cause the yellowness index of the polymeric base material (measured by ASTM D1925) to rise by at least 20% less, by at least 30% less, by at least 50% less, by at least 60% less, by at least 70%, or by at least 80% less, over five passes through an extruder at 260° C. in air, than that of the same polymeric base material to which an equivalent w/w amount of an equivalent antidegradant blend, absent one or both of component a. and component b., has been added.

The antidegradant blend, which when added to a polymeric base material, may cause the yellowness index of the polymeric base material (measured by ASTM D1925) to rise by less than 2.3, less than 2, less than 1.8, less than 1.5, or less than 1, over five passes through an extruder at 260° C. in air.

The antidegradant blend, which when added to a polymeric base material, may result in the yellowness index of the polymeric base material (measured by ASTM D1925) being at least 20% less, at least 40% less, at least 50% less, at least 80% less, at least 90% less, at least 95% less or at least 100% less, after five passes through an extruder at 260° C. in air, than that of the same polymeric base material to which an equivalent w/w amount of an equivalent antidegradant blend, absent one or both of component a. and component b., has been added.

The antidegradant blend, which when added to a polymeric base material, may result in the yellowness index of the polymeric base material (measured by ASTM D1925) being less than 2.2, less than 1, less than 0.5, less than 0.3, less than 0.1 or less than 0.05, after five passes through an extruder at 260° C. in air.

The antidegradant blend, which when added to a polymeric base material, may cause the melt flow rate of the polymeric base material (measured by ASTM D1238L with a temperature of 230° C., a 2.16 kg weight and a 2.095 mm die) to rise by less than 20 g/10 min, less than 12 g/10 min, less than 7 g/10 min, less than 6 g/10 min, or less than 2 g/10 min, over five passes through an extruder at 260° C. in air.

The antidegradant blend, which when added to a polymeric base material, may cause the melt flow rate of the polymeric base material (measured by ASTM D1238L with a temperature of 230° C., a 2.16 kg weight and a 2.095 mm die) to rise by less than 250%, by less than 110%, by less than 90%, by less than 80%, by less than 70%, or by less than 60%, over five passes through an extruder at 260° C. in air.

The antidegradant blend, which when added to a polymeric base material, may cause the yellowness index of the polymeric base material (measured by ASTM D1925) to rise less over three weeks in an oven at 130° C., than that of the same polymeric base material to which an equivalent w/w amount of an equivalent antidegradant blend, absent one or both of component a. and component b., has been added.

The antidegradant blend, which when added to a polymeric base material, may cause the yellowness index of the polymeric base material (measured by ASTM D1925) to rise by at least 10% less, by at least 15% less, by at least 20% less, or by at least 25% less, over three weeks in an oven at 130° C., than that of the same polymeric base material to which an equivalent w/w amount of an equivalent antidegradant blend, absent one or both of component a. and component b., has been added.

The antidegradant blend, which when added to a polymeric base material, may cause the yellowness index of the polymeric base material (measured by ASTM D1925) to rise by less than 6, less than 5.5, less than 5, or less than 4.6, over three weeks in an oven at 130° C.

The antidegradant blend, which when added to a polymeric base material, may result in the yellowness index of the polymeric base material (measured by ASTM D1925) being at least 10% less, at least 20% less, at least 30% less, or at least 35% less, after three weeks in an oven at 130° C., than that of the same polymeric base material to which an equivalent w/w amount of an equivalent antidegradant blend, absent one or both of component a. and component b., has been added.

The antidegradant blend, which when added to a polymeric base material, may result in the yellowness index of the polymeric base material (measured by ASTM D1925) being less than 5.4, less than 5, less than 4.5, less than 4, or less than 3.5 after three weeks in an oven at 130° C.

For the avoidance of doubt, all features relating to the antidegradant blend may apply, where appropriate, to the use of the antidegradant blend, methods pertaining to colour formation, and to the polymeric composition, and vice versa.

The invention will now be more particularly described with reference to the following examples.

### EXAMPLES

### Examples 1 to 23

### Preparation of the Polymeric Composition

The polymeric base material was a commercially available polypropylene homopolymer for samples 1 to 4 and 8 to 23, and a polypropylene homopolymer with a lower MFR for samples 5 to 7.

Numerous antidegradant blends were prepared.

Table 1 shows the different components that were used in the antidegradant blends.

TABLE 1

| Component | Shorthand | Type |
|---|---|---|
| Sodium hypophosphite | Na Hyp | Inorganic phosphite antioxidant |
| ALKANOX ™ 240 | A240 | Organic phosphite antioxidant |
| ANOX ™ 20 | A20 | Phenolic antioxidant |
| IRGASTAB ™ FS042 | FS042 | Bis(octadecyl)hydroxylamine 65% |
| | | (CAS 143925-92-2) |
| GENOX ™ EP | EP | Antioxidant amine oxide (delivers a |
| | | hydroxylamine on heating) |
| | | (CAS 204933-93-7) |

Table 2 shows the various antidegradant blends that were prepared. The % amounts shown in the table are % by weight of the overall polymeric composition.

TABLE 2

| | Na | | | | | |
|---|---|---|---|---|---|---|
| | Hyp | A240 | A20 | FS042 | EP | Total |
| Sample | (%) | (%) | (%) | (%) | (%) | (%) |
| 1 (Comp) | — | 0.08 | 0.04 | — | — | 0.12 |
| 2 (Comp) | — | 0.08 | 0.04 | 0.015 | — | 0.135 |
| 3 | 0.0075 | 0.08 | 0.04 | 0.0075 | — | 0.135 |
| 4 (Comp) | 0.015 | 0.08 | 0.04 | — | — | 0.135 |
| 5 (Comp) | — | 0.0925 | 0.0925 | 0.03 | — | 0.215 |
| 6 | 0.015 | 0.0925 | 0.0925 | 0.015 | — | 0.215 |
| 7 (Comp) | 0.03 | 0.0925 | 0.0925 | — | — | 0.215 |
| 8 (Comp) | — | 0.08 | 0.04 | — | — | 0.12 |
| 9 | 0.015 | 0.08 | 0.04 | 0.015 | — | 0.15 |
| 10 (Comp) | — | 0.08 | 0.04 | 0.03 | — | 0.15 |
| 11 (Comp) | 0.03 | 0.08 | 0.04 | — | — | 0.15 |
| 12 | 0.01 | 0.08 | 0.04 | 0.02 | — | 0.15 |
| 13 | 0.02 | 0.08 | 0.04 | 0.01 | — | 0.15 |
| 14 | 0.025 | 0.08 | 0.04 | 0.005 | — | 0.15 |
| 15 | 0.015 | 0.08 | 0.04 | 0.005 | — | 0.14 |
| 16 | 0.0275 | 0.08 | 0.04 | 0.0025 | — | 0.15 |
| 17 | 0.02 | 0.08 | 0.04 | 0.0025 | — | 0.1425 |
| 18 | 0.01 | 0.08 | 0.04 | 0.0025 | — | 0.1325 |
| 19 | 0.025 | 0.08 | 0.04 | — | 0.005 | 0.15 |
| 20 | 0.015 | 0.08 | 0.04 | — | 0.015 | 0.15 |
| 21 (Comp) | — | 0.08 | 0.04 | — | 0.03 | 0.15 |
| 22 (Comp) | — | 0.08 | 0.04 | — | — | 0.12 |
| 23 | 0.0275 | 0.08 | 0.04 | — | 0.0025 | 0.15 |

Samples 1, 2, 4, 5, 7, 8, 10, 11, 21 and 22 are comparative examples, in which samples 1, 8 and 22 represent industry available antidegradant blends. Each of the above-identified antidegradant blends was compounded with the polypropylene base material in an extruder at a temperature of 230° C. under nitrogen to form a polymeric composition.

### Colour Stability

Each of the polymeric compositions referenced in Table 2 were multi-passed through an extruder at 260° C. under air. Extrusion experiments were performed on a 25 mm SS BRABENDER™ extruder. After each pass through the extruder the polymer sample was cooled in a water bath, dried and chipped to give pellets which were analysed and subjected to the same procedure again. The discolouration of the compositions was measured in terms of Yellowness Index using a colorimeter (XRITE™ Color i7) according to YI ASTM D1925. Each YI measurement is the average of 4 measured values. YI values were taken following compounding (pass 0) and after passes 1, 3 and 5. The lower the YI value, the less discolouration of the composition. The results are shown in Table 3.

TABLE 3

YI Value

| Sample | Pass 0 | Pass 1 | Pass 3 | Pass 5 |
|---|---|---|---|---|
| 1 (Comp) | −0.26 | 2.71 | 5.60 | 8.03 |
| 2 (Comp) | −0.23 | 1.35 | 3.98 | 6.27 |
| 3 | −0.59 | −0.45 | −0.02 | 0.90 |
| 4 (Comp) | −1.10 | 0.23 | 1.49 | 2.28 |
| 5 (Comp) | 0.01 | 1.49 | 4.67 | 8.44 |
| 6 | −0.33 | 0.08 | 0.08 | 1.23 |
| 7 (Comp) | −0.23 | 1.29 | 2.47 | 3.10 |
| 8 (Comp) | −0.56 | 1.45 | 3.93 | 5.46 |
| 9 | −0.48 | 0.45 | 0.83 | 1.72 |
| 10 (Comp) | −0.35 | 1.01 | 2.77 | 4.34 |
| 11 (Comp) | −1.02 | 0.09 | 0.83 | 1.10 |
| 12 | −0.74 | −0.35 | 0.19 | 0.66 |
| 13 | −0.68 | −0.21 | 0.37 | 1.08 |
| 14 | −1.04 | −0.31 | −0.08 | 0.32 |
| 15 | −0.84 | −0.53 | −0.05 | 0.56 |
| 16 | −0.72 | −0.64 | −0.37 | 0.02 |
| 17 | −1.06 | −0.25 | −0.06 | 0.80 |
| 18 | −1.20 | −0.48 | 0.01 | 0.50 |
| 19 | −0.95 | −0.64 | −0.38 | 0.27 |
| 20 | −0.71 | −0.47 | −0.04 | 0.23 |
| 21 (Comp) | 0.29 | 1.84 | 4.18 | 5.13 |
| 22 (Comp) | −0.44 | 1.72 | 5.08 | 6.91 |
| 23 | −0.96 | −0.99 | −0.62 | −0.14 |

From the results, it can be seen that the polymeric compositions stabilised with the antidegradant blends in accordance with the present invention (samples 3, 6, 9, 12 to 20 and 23) show significantly less discolouration than the polymeric compositions stabilised with the industry available antidegradant blends (samples 1, 8 and 22). It has surprisingly been found that the best performance, when using a mixture of sodium hypophosphite and an aminic component along with phenolic and organic phosphite antioxidants, occurs when the blend consists of a smaller proportion of hydroxylamine (1-20%) and a larger proportion of sodium hypophosphite (80-99%). This can most clearly be seen with samples 16 and 23.

### Melt Flow Rate

The melt flow rate of the polymeric composition of samples 1 to 23 was determined following compounding (pass 0) and after pass 5, using a CEAST™ 7026 melt flow tester according to standard test method ASTM D1238L with a temperature of 230° C., a 2.16 kg weight and a 2.095 mm die. An increase in the melt flow rate is indicative of unfavourable degradation of the sample, because it is desirable for the properties of the polymeric composition to be maintained, rather than changed, on processing. The results are shown in Table 4.

TABLE 4

Melt Flow Rate (g/10 min)

| Sample | Pass 0 | Pass 5 |
|---|---|---|
| 1 (Comp) | 9.77 | 14.91 |
| 2 (Comp) | 9.26 | 16.35 |
| 3 | 8.85 | 14.30 |
| 4 (Comp) | 10.18 | 16.27 |
| 5 (Comp) | 2.81 | 5.57 |
| 6 | 2.34 | 4.07 |
| 7 (Comp) | 2.34 | 4.52 |
| 8 (Comp) | 8.82 | 15.40 |
| 9 | 8.94 | 15.01 |
| 10 (Comp) | 9.23 | 17.56 |
| 11 (Comp) | 9.43 | 14.39 |
| 12 | 8.63 | 13.46 |
| 13 | 8.64 | 14.75 |
| 14 | 8.76 | 14.23 |
| 15 | 8.82 | 13.70 |
| 16 | 8.84 | 14.71 |
| 17 | 9.41 | 15.00 |
| 18 | 9.09 | 15.59 |
| 19 | 8.87 | 14.61 |
| 20 | 8.86 | 14.64 |
| 21 (Comp) | 9.31 | 17.24 |
| 22 (Comp) | 8.91 | 15.47 |
| 23 | 8.35 | 14.63 |

From the results it can be seen that the polymeric compositions stabilised using the antidegradant blends according to the present invention (samples 3, 6, 9, 12 to 20 and 23) retained melt flow rate similarly to the polymeric compositions stabilised using industry available antidegradant blends (samples 1, 8, and 22).

### Colour Fastness to Burnt Gas Fumes

The fastness of a polymer and additives to burnt gas fumes is determined on a semi-quantitative basis by exposing the compounded polymer pellets to burnt gas fumes in a chamber at a temperature of 60° C. for a period of 48 hrs and monitoring the discolouration of the compositions in terms of Yellowness Index using a colorimeter at 24 hrly intervals according to the procedure of AATCC 23. The lower the YI value, the less discolouration of the composition. The results are shown in Table 5.

TABLE 5

| | YI Value | | |
|---|---|---|---|
| Sample | 0 hrs | 24 hrs | 48 hrs |
| 8 (Comp) | −0.53 | 4.92 | 7.82 |
| 9 | −0.45 | 3.56 | 5.92 |
| 10 (Comp) | −0.38 | 1.05 | 2.87 |
| 11 (Comp) | −1.08 | 3.10 | 5.44 |
| 12 | −0.69 | 2.44 | 4.52 |
| 13 | −0.51 | 3.92 | 6.81 |
| 14 | −0.93 | 2.49 | 5.00 |
| 15 | −0.99 | 4.20 | 7.44 |
| 16 | −0.92 | 4.41 | 8.26 |

From the results, it can be seen that the polymeric compositions stabilised with the antidegradant blend in accordance with the present invention (samples 9 and 12 to 16) show less or equal discolouration to the polymeric compositions stabilised with the comparative blends (samples 8, 10, and 11).

### Colour Fastness to Oven Aging

The fastness of a polymer and additives to oven aging is determined on a semi-quantitative basis by exposing the compounded polymer pellets in a glass petri dish to oven aging at 130° C. for a period of 3 weeks and monitoring the discolouration of the compositions in terms of Yellowness Index using a colorimeter (XRITE™ Color i7) according to YI ASTM D1925 at weekly intervals. The lower the YI value, the less discolouration of the composition. The results are shown in Table 6.

TABLE 6

YI Value

| Sample | 0 wks | 1 wk | 2 wks | 3 wks |
|---|---|---|---|---|
| 8 (Comp) | −0.77 | 2.08 | 4.12 | 5.41 |
| 16 | −1.16 | 0.25 | 1.78 | 3.41 |

From the results, it can be seen that the polymeric composition stabilised with the antidegradant blend in accordance with the present invention (Sample 16) shows less discolouration than the polymeric composition stabilised with the industry available blend (Sample 8).

### Examples 24 to 36

### Preparation of the Polymeric Composition

For samples 24 to 30, the polymeric base material was a polypropylene homopolymer from a first source.

For samples 31 to 34, the polymeric base material was a lower MFR polypropylene homopolymer from a second source.

For samples 35 and 36, the polymeric base material was a polypropylene homopolymer from a third source.

Numerous antidegradant blends were prepared.

Table 7 shows the different components that were used in the antidegradant blends.

TABLE 7

| Component | Shorthand | Type |
|---|---|---|
| Sodium hypophosphite | Na Hyp | Inorganic phosphite antioxidant |
| ALKANOX ™ 240 | A240 | Organic phosphite antioxidant |
| ANOX ™ 20 | A20 | Phenolic antioxidant |
| IRGASTAB ™ FS042 | FS042 | Bis(octadecyl)hydroxylamine 65% |
| | | (CAS 143925-92-2) |
| DHT-4V | DHT | Hydrotalcite (CAS 11097-59-9) |
| ULTRANOX ™ 626 | U626 | Organic phosphite antioxidant |
| ANOX ™ IC-14 | IC-14 | Phenolic antioxidant |
| Calcium Stearate | CaSt | Acid scavenger |

Table 8 shows the various antidegradant blends that were prepared. The % amounts shown in the table are % by weight of the overall polymeric composition.

TABLE 8

| | Na | | | | | | | | |
|---|---|---|---|---|---|---|---|---|---|
| | Hyp | A240 | A20 | FS042 | DHT | U626 | IC-14 | CaSt | Total |
| Sample | (%) | (%) | (%) | (%) | (%) | (%) | (%) | (%) | (%) |
| 24 (Comp) | — | 0.08 | 0.04 | — | — | — | — | 0.03 | 0.15 |
| 25 | 0.0023 | 0.08 | 0.04 | 0.0002 | — | — | — | 0.03 | 0.1525 |
| 26 | 0.0046 | 0.08 | 0.04 | 0.0004 | — | — | — | 0.03 | 0.155 |
| 27 | 0.0092 | 0.08 | 0.04 | 0.0008 | — | — | — | 0.03 | 0.16 |
| 28 | 0.005 | 0.08 | 0.04 | 0.0025 | — | — | — | 0.03 | 0.1575 |
| 29 | 0.01 | 0.08 | 0.04 | 0.0025 | — | — | — | 0.03 | 0.1625 |
| 30 | 0.015 | 0.08 | 0.04 | 0.0025 | — | — | — | 0.03 | 0.1675 |
| 31 (Comp) | — | 0.11 | 0.11 | — | 0.03 | — | — | — | 0.25 |
| 32 | 0.0275 | 0.11 | 0.11 | 0.0025 | — | — | — | — | 0.25 |
| 33 (Comp) | — | 0.14 | — | — | 0.03 | 0.063 | — | — | 0.233 |
| 34 | 0.0275 | 0.14 | — | 0.0025 | — | 0.063 | — | — | 0.233 |
| 35 (Comp) | — | 0.1 | — | — | — | — | 0.05 | 0.04 | 0.19 |
| 36 | 0.015 | 0.1 | — | 0.0014 | — | — | 0.05 | 0.04 | 0.2064 |

Samples 24, 31, 33 and 35 are comparative examples which represent industry available antidegradant blends. Each of the above-identified antidegradant blends were compounded with the polypropylene base material in an extruder at a temperature of 230° C. under nitrogen to form a polymeric composition.

### Colour Stability

Each of the polymeric compositions referenced in Table 8 were multi-passed through an extruder at 260° C. under air. Extrusion experiments were performed on a 25 mm SS BRABENDER™ extruder. After each pass through the extruder the polymer sample was cooled in a water bath, dried and chipped to give pellets which were analysed and subjected to the same procedure again. The discolouration of the compositions was measured in terms of Yellowness Index (YI) using a colorimeter (XRITE™ Color i7) according to YI ASTM D1925. YI values were taken following compounding (pass 0) and after passes 1, 3 and 5. The lower the YI values, the less discolouration of the composition. The results are shown in Table 9.

TABLE 9

YI Value

| Sample | Pass 0 | Pass 1 | Pass 3 | Pass 5 |
|---|---|---|---|---|
| 24 (Comp) | −0.60 | −0.01 | 0.84 | 2.19 |
| 25 | −0.34 | 0.01 | 1.10 | 1.88 |
| 26 | −0.67 | −0.36 | 0.58 | 0.99 |
| 27 | −0.53 | −0.45 | 0.19 | 0.53 |
| 28 | −0.67 | −0.31 | 0.15 | 0.81 |
| 29 | −0.53 | −0.37 | 0.06 | 0.61 |
| 30 | −0.61 | −0.19 | 0.33 | 0.76 |
| 31 (Comp) | −0.99 | 0.69 | 2.46 | 3.90 |
| 32 | 0.01 | 0.96 | 1.85 | 2.80 |
| 33 (Comp) | −2.48 | 0.17 | 1.88 | 3.57 |
| 34 | −0.45 | 0.14 | 1.38 | 1.70 |
| 35 (Comp) | −0.78 | −0.54 | 1.04 | 2.5 |
| 36 | −0.72 | −0.45 | 0.74 | 2.05 |

From the results, it can be seen that the polymeric compositions stabilised with the antidegradant blends in accordance with the present invention (samples 25 to 30, 32, 34 and 36) show significantly less discolouration than the polymeric compositions stabilised with the respective industry available antidegradant blends (samples 24, 31, 33 and 35).

### Melt Flow Rate

The melt flow rate of the polymeric compositions of samples 24 to 36 was determined following compounding (pass 0) and after pass 5, using a CEAST™ 7026 melt flow tester according to standard test method ASTM D1238L with a temperature of 230° C., a 2.16 kg weight and a 2.095 mm die. An increase in the melt flow rate is indicative of unfavourable degradation of the sample. The results are shown in Table 10.

TABLE 10

Melt Flow Rate (g/10 min)

| Sample | Pass 0 | Pass 5 |
|---|---|---|
| 24 (Comp) | 9.22 | 17.93 |
| 25 | 9.45 | 16.87 |
| 26 | 9.40 | 17.25 |
| 27 | 9.56 | 16.96 |
| 28 | 8.63 | 16.14 |
| 29 | 9.30 | 16.45 |
| 30 | 9.49 | 16.72 |
| 31 (Comp) | 0.60 | 1.48 |
| 32 | 0.64 | 1.44 |
| 33 (Comp) | 0.57 | 1.19 |
| 34 | 0.63 | 1.18 |
| 35 (Comp) | 19.14 | 28.54 |
| 36 | 19.19 | 26.19 |

From the results it can be seen that the polymeric compositions stabilised using the antidegradant blends according to the present invention (samples 25 to 30, 32, 34 and 36) retained melt flow rate similarly to the polymeric compositions stabilised using the respective industry available antidegradant blends (samples 24, 31, 33 and 35).

### Examples 37 to 41

### Preparation of the Polymeric Composition

The polymeric base material was a polypropylene homopolymer.

Numerous antidegradant blends were prepared.

Table 11 shows the different components that were used in the antidegradant blends.

TABLE 11

| Component | Shorthand | Type |
|---|---|---|
| Sodium hypophosphite | Na HypM | Inorganic phosphite antioxidant |
| monohydrate | | |
| ALKANOX ™ 240 | A240 | Organic phosphite antioxidant |
| ANOX ™ 20 | A20 | Phenolic antioxidant |
| IRGASTAB ™ FS042 | FS042 | Bis(octadecyl)hydroxylamine 65% |
| | | (CAS 143925-92-2) |
| Disodium phosphite | DSP | Inorganic phosphite antioxidant |
| pentahydrate | | |

Table 12 shows the various antidegradant blends that were prepared. The % amounts shown in the table are % by weight of the overall polymeric composition.

TABLE 12

| | Na | | | | | |
|---|---|---|---|---|---|---|
| | HypM | A240 | A20 | FS042 | DSP | Total |
| Sample | (%) | (%) | (%) | (%) | (%) | (%) |
| 37 (Comp) | — | 0.08 | 0.04 | — | — | 0.15 |
| 38 (Comp) | — | 0.08 | 0.04 | — | 0.015 | 0.135 |
| 39 | — | 0.08 | 0.04 | 0.0025 | 0.015 | 0.1375 |
| 40 | 0.0075 | 0.08 | 0.04 | 0.0025 | — | 0.13 |
| 41 | 0.0037 | 0.08 | 0.04 | 0.0025 | — | 0.1262 |

Sample 37 is a comparative example which represents an industry available antidegradant blend. Sample 38 is also a comparative example which does not involve a hydroxylamine component. Each of the above-identified antidegradant blends were compounded with the polypropylene homopolymer base material in an extruder at a temperature of 230° C. under nitrogen to form a polymeric composition.

### Colour Stability

Each of the polymeric compositions were multi-passed through an extruder at 260° C. under air. Extrusion experiments were performed on a 25 mm SS BRABENDER™ extruder. After each pass through the extruder the polymer sample was cooled in a water bath, dried and chipped to give pellets which were analysed and subjected to the same procedure again. The discolouration of the compositions was measured in terms of Yellowness Index (YI) using a colorimeter (XRITE™ Color i7) according to YI ASTM D1925. YI values were taken following compounding (pass 0) and after passes 1, 3 and 5. The lower the YI value, the less discolouration of the composition. The results are shown in Table 13.

TABLE 13

YI Value

| Sample | Pass 0 | Pass 1 | Pass 3 | Pass 5 |
|---|---|---|---|---|
| 37 (Comp) | 0.74 | 2.16 | 4.34 | 5.89 |
| 38 (Comp) | 0.00 | 1.08 | 3.29 | 4.58 |
| 39 | −0.35 | 0.66 | 1.85 | 2.66 |
| 40 | 0.10 | 0.12 | 1.24 | 2.33 |
| 41 | 0.24 | 0.51 | 1.93 | 2.65 |

From the results, it can be seen that the polymeric compositions stabilised with the antidegradant blends in accordance with the present invention (samples 39, 40 and 41) show less discolouration than the polymeric compositions stabilised with the industry available antidegradant blend (Sample 37). The results also highlight the important synergistic effect of the hydroxylamine and inorganic antioxidant in the antidegradant blend—samples 39, 40 and 41 outperform the sample containing only the inorganic antioxidant (sample 38) in terms of reduced discolouration.

### Melt Flow Rate

The melt flow rate of the polymeric composition of samples 37 to 41 was determined following compounding (pass 0) and after pass 5, using a CEAST™ 7026 melt flow tester according to standard test method ASTM D1238L with a temperature of 230° C., a 2.16 kg weight and a 2.095 mm die. An increase in the melt flow rate is indicative of unfavourable degradation of the sample. The results are shown in Table 14.

TABLE 14

Melt Flow Rate (g/10 min)

| Sample | Pass 0 | Pass 5 |
|---|---|---|
| 37 (Comp) | 7.93 | 11.97 |
| 38 (Comp) | 8.31 | 13.18 |
| 39 | 8.72 | 12.99 |
| 40 | 8.65 | 12.86 |
| 41 | 8.80 | 12.90 |

From the results, it can be seen that the polymeric compositions stabilised using the antidegradant blends according to the present invention (samples 39, 40 and 41) retained melt flow rate similarly to the polymeric composition stabilised using the industry standard antidegradant blend (Sample 37).

1. An antidegradant blend, comprising:
a. an aminic component comprising a hydroxylamine and/or a hydroxylamine precursor; and
b. an inorganic antioxidant or reducing agent.

2. The antidegradant blend according to claim 1, wherein the antidegradant blend further comprises one or more of: a phenolic antioxidant, an organic phosphite antioxidant, a sulphur-containing antioxidant, and an anti-acid.

3. (canceled)

4. The antidegradant blend according to claim 1, wherein the inorganic antioxidant or reducing agent is a phosphorus-containing compound and/or a sulphur-containing compound.

5. The antidegradant blend according to claim 1, wherein the inorganic antioxidant or reducing agent is selected from the group consisting of a metal phosphite, a metal hypophosphite, a metal thiosulphate, a metal bisulphite, a metal metabisulphite, a metal hydrosulphite and mixtures thereof.

6. The antidegradant blend according to claim 1, wherein the inorganic antioxidant or reducing agent is a phosphorus-containing compound, a metal phosphite and/or a metal hypophosphite.

7. The antidegradant blend according to claim 6, wherein the inorganic antioxidant or reducing agent is a metal hypophosphite.

8. The antidegradant blend according to claim 1, wherein the inorganic antioxidant or reducing agent is present in an amount of from about 5% to about 25%, by weight of the antidegradant blend; and/or
wherein the inorganic antioxidant or reducing agent is a solid at a temperature of about 50° C. or lower, and about 1 atmosphere pressure.

9. The antidegradant blend according to claim 1, wherein the hydroxylamine has the general formula RₓR_{y}NOH, wherein each R independently denotes an optionally branched hydrocarbyl group having from 1 to 25 carbon atoms.

10. The antidegradant blend according to claim 1, wherein the hydroxylamine precursor is an amine oxide.

11. The antidegradant blend according to claim 10, wherein the amine oxide has the general formula RₓR_{y}R_{z}NO, wherein each R independently denotes an optionally branched hydrocarbyl group having from 1 to 25 carbon atoms.

12. The antidegradant blend according to claim 1, wherein
the aminic component is a solid at a temperature of about 50° C. or lower, and about 1 atmosphere pressure; and/or
wherein the aminic component is present in an amount of from about 1% to about 10%, by weight of the antidegradant blend; and/or
wherein the ratio of inorganic antioxidant or reducing agent to aminic component is from from about 2:1 to about 12:1.

13. The antidegradant blend according to claim 2, wherein the antidegradant blend comprises a phenolic antioxidant, and wherein the phenolic antioxidant is a partially hindered phenolic antioxidant or a hindered phenolic antioxidant.

14. The antidegradant blend according to claim 2, wherein the antidegradant blend comprises a phenolic antioxidant, and wherein the phenolic antioxidant is present in an amount of from about 20% to about 45%, by weight of the antidegradant blend.

15. The antidegradant blend according to claim 2, wherein the antidegradant blend comprises an organic phosphite antioxidant, and wherein the organic phosphite antioxidant is present in an amount of from about 30% to about 70%, by weight of the antidegradant blend.

16. The antidegradant blend according to claim 2, wherein the antidegradant blend comprises a sulphur-containing antioxidant, and wherein the sulphur-containing antioxidant comprises one or more thioether groups and/or one or more thioester groups.

17. The antidegradant blend according to claim 16, wherein the sulphur-containing antioxidant is present in an amount of from about 30% to about 70%, by weight of the antidegradant blend.

18. The antidegradant blend according to claim 2, wherein the antidegradant blend comprises an anti-acid, and wherein the anti-acid is present in an amount of from about 8% to about 25%, by weight of the antidegradant blend.

19. The antidegradant blend according to claim 18, wherein the anti-acid is selected from the group consisting of lithium stearate, sodium stearate, calcium stearate, zinc stearate, magnesium stearate, aluminum stearate, zinc oxide, magnesium oxide, titanium dioxide calcium carbonate, hydrotalcite, and mixtures thereof.

20. An antidegradant blend, comprising:
a. an aminic component comprising a hydroxylamine and/or a hydroxylamine precursor;
b. an inorganic phosphite antioxidant;
c. a phenolic antioxidant; and
d. an organic phosphite antioxidant.

21. An antidegradant blend, comprising:
a. bis(octadecyl)hydroxylamine and/or amines, bis(hydrogenated rape-oil alkyl)methyl, N-oxides, present in an amount of from about 0.1% to about 30% by weight of the antidegradant blend;
b. sodium hypophosphite, present in an amount of from about 0.1% to about 40% by weight of the antidegradant blend;
c. tetrakismethylene(3,5-di-t-butyl-4-hydroxyhydrocinnamate) methane, present in an amount of from about 1% to about 60% by weight of the antidegradant blend; and
d. tris(2,4-di-t-butylphenyl)phosphite, present in an amount of from about 10% to about 90% by weight of the antidegradant blend.

22. (canceled)

23. A polymeric composition, comprising a polymeric base material and an antidegradant blend according to claim 1.

24. The polymeric composition according to claim 23, wherein the antidegradant blend is present in an amount of from about 0.1% to about 1%, by weight of the polymeric composition, and/or
wherein the aminic component is present in the polymeric composition in an amount less than about 45 ppm, and/or
wherein the polymeric base material is selected from the group consisting of a polyolefin, polystyrene, polyacrylonitrile, a polyacrylate, a polyurethane, a polyamide, a polyester, a polycarbonate, polyvinyl chloride, an elastomer, a rubber, and mixtures, blends, and copolymers thereof.

25. An article manufactured from a polymeric composition according to claim 23.

26. The polymeric composition according to claim 23, having a yellowness index of the polymeric base material, as measured by ASTM D1925, that rises less over five passes through an extruder at 260° C. in air, than that of the same polymeric base material to which an equivalent w/w amount of an equivalent antidegradant blend, absent one or both of component (a) and component (b) has been added.

27. The antidegradant blend according to claim 9, wherein the hydroxylamine is selected from the group consisting of N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N-hexadecyl-N-octadecylhydroxylamine; N-heptadecyl-N-octadecylhydroxylamine; bis(octadecyl)hydroxylamine; and mixtures thereof.

28. The antidegradant blend according to claim 10, wherein the amine oxide is bis(hydrogenated rape-oil alkyl)methyl, N-oxides.
